(19) United States
(12) Patent Application Publication
(10) Pub. No.: US 2004/0201806 A1
(43) Pub. Date: Oct. 14, 2004

(54) Method of forming multi-domain on alignment film, method of manufacturing liquid crystal display apparatus using the same, liquid crystal alignment apparatus and liquid crystal display apparatus

(75) Inventors: Dae-Ho Choo, Yongin-si (KR); Hak-Jin Kim, Osan-si (KR); Hong-Gyun Kim, Suwon-si (KR); Hwan-Kyeong Jeong, Cheongju-si (KR); Bong-Woo Lee, Cheonan-si (KR)

Correspondence Address: McGuireWoods, Suite 1800, 1750 Tysons Boulevard, McLean, VA, 22102-4215, US

(73) Assignee: Samsung Electronics Co., Ltd.

(21) Appl. No.: 10/679,625

(22) Filed: Oct. 7, 2003

(30) Foreign Application Priority Data
Apr. 14, 2003 (KR) 2003-23382

(51) Int. Cl. G02F 1/1337

(52) U.S. Cl. 349/129

(57) ABSTRACT

According to the method of forming a multi-domain for aligning liquid crystal, an alignment film is formed on a substrate. The alignment film is scanned with an atomic beam irradiated in a first direction to form a first domain in a first region of the first alignment film. Then, the alignment film is scanned with the atomic beam irradiated in a second direction to form a second domain in a second region of the first alignment film. Thus, the multi-domain is formed by non-contacting method, so that a number of process and a time used for manufacturing the multi-domain are reduced.

### CROSS-REFERENCE TO RELATED APPLICATIONS

This application relies for priority upon Korean Patent Application No.2003-23382 filed on Apr. 14, 2003, the contents of which are herein incorporated by reference in its entirety.

### BACKGROUND OF THE INVENTION

1. Field of the Invention

The present invention relates to a method of forming a multi-domain on alignment film, a method of manufacturing a liquid crystal display apparatus using the same, a liquid crystal aligning apparatus and a liquid crystal display apparatus, and more particularly to a method of forming a multi-domain on alignment film by atomic beam, a method of manufacturing a liquid crystal display apparatus using the same, a liquid crystal aligning apparatus and a liquid crystal display apparatus having wide viewing angle.

2. Description of the Related Art

Generally, a liquid crystal display apparatus displays an image by using liquid crystal. The liquid crystal display apparatus adjust an arrangement of the liquid crystal of small area called pixel, so that a transmittance of a white light is controlled. Then, the white light is filtered into a color light by a color filter. Color lights of each of pixels are combined, so that an image is formed.

A viewing angle of a general liquid crystal display apparatus is narrow in comparison with a cathode ray tube (CRT) display apparatus, because an advancing direction of the light is adjusted by the liquid crystal.

In case of a portable computer, narrow viewing angle is not so defective. However, when a liquid crystal display apparatus is used for a television receiver set, narrow viewing angle becomes defective, because a person deviated from the television receiver set, the person cannot see clear image.

Thus, many researches have been performed so as to widen the viewing angle recently as follows.

An In-Plan Switching (IPS) type liquid crystal display apparatus has been developed.

A pixel electrode and a common electrode are disposed in parallel on onesubstrate in case of the In-Plan Switching type liquid crystal display apparatus.

Fringe electric fields are formed near the common electrode and the pixel electrode, so that an arrangement of the liquid crystal molecules is adjusted to widen the viewing angle.

However, although the In-Plan Switching type liquid crystal display apparatus has widened the viewing angle, a luminance of the In-Plan Switching type liquid crystal display apparatus is lowered. Further, the In-Plan Switching type liquid crystal display apparatus has a residual image, so that an expensive film for eliminating the residual image is used.

A vertical alignment type liquid crystal display apparatus has been developed. In case of the vertical alignment type liquid crystal display apparatus, the pixel electrode and the common electrode face each other. A liquid crystal is interposed between the pixel electrode and the common electrode. The liquid crystal molecules are aligned vertically with reference to the pixel electrode and the common electrode.

The common electrode or the pixel electrode may be patterned so as to widen the viewing angle. A protrusion may be formed on the common electrode or on the pixel electrode so as to widen the viewing angle.

A vertical alignment type liquid crystal display apparatus having the patterned pixel electrode or the patterned common electrode is referred to as ‘Patterned Vertical Alignment (PVA) type liquid crystal display apparatus’.

A vertical alignment type liquid crystal display apparatus having the protrusion formed on the common electrode or on the pixel electrode is referred to as ‘Massive Vertical Alignment (MVA) type liquid crystal display apparatus’.

However, in order to manufacture the PVA type liquid crystal display apparatus, additional procedures are performed so as to pattern the common electrode. The common electrode having protrusion of the MVA type liquid crystal display apparatus may be electrically shorted with the pixel electrode.

In case of a twisted nematic liquid crystal display apparatus, a compensating film for widening the viewing angle is used. However, the compensating film is expensive, and increases a weight and a volume of the liquid crystal display apparatus.

### SUMMARY OF THE INVENTION

Accordingly, the present invention is provided to substantially obviate one or more problems due to limitations and disadvantages of the related art.

It is a feature of the present invention to provide a method of forming a multi-domain on an alignment film by non-contacting method.

In one aspect of the present invention, a method of manufacturing a liquid crystal display device having wide viewing angle is provided.

In another aspect of the present invention, a liquid crystal display device having wide viewing angle is provided.

In another aspect of the present invention, a liquid crystal alignment apparatus is provided.

According to the method of forming a multi-domain for aligning liquid crystal, an alignment film is formed on a substrate. The alignment film is scanned with an atomic beam irradiated in a first direction to form a first domain in a first region of the first alignment film. Then, the alignment film is scanned with the atomic beam irradiated in a second direction to form a second domain in a second region of the first alignment film.

According to the method of manufacturing a liquid crystal display device, first and second electrodes are formed on a first substrate. A first alignment film is formed on the first substrate. An atomic beam is irradiated in a first alignment region of the first alignment film in a first direction. The first alignment region corresponds to a first region of the first electrode. The atomic beam is irradiated in a second alignment region of the first alignment film in a second direction. The second alignment region corresponds to a second region of the first electrode. Then, the first substrate is assembled with a second substrate.

According to another method of manufacturing a liquid crystal display device, a first electrode is formed on a first substrate. A second electrode is formed on a second substrate. A first alignment film is formed on the first substrate. An atomic beam is irradiated in a first alignment region of the first alignment film in a first direction. The first alignment region corresponds to a first region of the first electrode. The atomic beam is irradiated in a second alignment region of the first alignment film in a second direction. The second alignment region corresponds to a second region of the first electrode. The first and second substrates are assembled with each other.

According to the liquid crystal display device having wide viewing angle, the liquid crystal display device includes first and second electrodes, first and second alignment films, and a liquid crystal layer. The first and second substrates face with each other. The first and second electrodes are disposed between the first and second substrates. The first alignment film is formed on the first substrate. The first alignment film has first and second polarized functional groups for aligning liquid crystal molecules. The first polarized functional group is formed in a first alignment region corresponding to a first region of the first electrode. The first polarized functional group is formed in a first direction. The second polarized functional group is formed on a second alignment region corresponding to a second region of the first electrode. The second polarized functional group is formed in a second direction. The second alignment film is formed on the second substrate. The liquid crystal layer is interposed between the first and second substrates.

According to a liquid crystal alignment apparatus, the liquid crystal alignment apparatus includes a base body, an atomic beam generator, an atomic beam generator and an atomic beam blocking unit. The base body supports a substrate having first and second faces. An alignment film is formed on the first face. The atomic beam generator irradiates an atomic beam. The atomic beam generator moves along the alignment film to scan the alignment film. The atomic beam blocking unit is disposed between the base body and the atomic beam generator. The atomic beam blocking unit includes a mask having an opening. The atomic beam generated from the atomic beam generator is irradiated onto a portion of the alignment film. The portion of the alignment film is exposed through the opening of the mask.

According to the method of forming a multi-domain for aligning liquid crystal, the multi-domain is formed by non-contacting method. A number of process and a time used for manufacturing the multi-domain are reduced.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is a flow chart showing a method of forming a multi-domain on an alignment film by atomic beam;

FIG. 2 is a schematic cross-sectional view showing an alignment film formed on a substrate according to a first step of FIG. 1;

FIG. 3 is a schematic cross-sectional view showing a method of forming a first domain on a first region of an alignment film by a first mask according to a second step of FIG. 1;

FIG. 4 is a flow chart showing a method of forming an atomic beam of second and third steps of FIG. 1;

FIG. 5 is a schematic cross-sectional view showing a method of forming a second domain on a second region of an alignment film by a second mask according to a third step of FIG. 1;

FIG. 6 is a schematic cross-sectional view showing a method of forming a first domain on a first region of an alignment film by a first floating mask according to a second step of FIG. 1;

FIG. 7 is a schematic cross-sectional view showing a method of forming a second domain on a second region of an alignment film by a second floating mask according to a third step of FIG. 1;

FIG. 8 is a plan view showing first and second floating mask of FIGS. 6 and 7;

FIG. 9 is a flow chart showing a method of manufacturing a liquid crystal display apparatus having wide viewing angle, according to a first exemplary embodiment of the present invention;

FIG. 10 is schematic cross-sectional view showing first and second substrates according to a first step of FIG. 9;

FIG. 11 is a schematic cross-sectional view showing an alignment film formed on a first substrate having a first electrode formed thereon according to a second step of FIG. 9;

FIG. 12 is a schematic cross-sectional view showing a method of forming a first domain on a first region of an alignment film according to a third step of FIG. 9;

FIG. 13 is a plan view showing a first domain of FIG. 12;

FIG. 14 is a schematic cross-sectional view showing a method of forming a second domain on a second region of an alignment film according to a fourth step of FIG. 9;

FIG. 15 is a plan view showing a second domain of FIG. 14;

FIG. 16 is a schematic cross-sectional view showing first and second substrates assembled together according to a fifth step of FIG. 9;

FIG. 17 is a flow chart showing a method of manufacturing a liquid crystal display apparatus having wide viewing angle, according to a second exemplary embodiment of the present invention;

FIG. 18 is a schematic cross-sectional view showing a second alignment film formed on a second electrode of a second substrate according to a first step of FIG. 17;

FIG. 19 is a schematic cross-sectional view showing a method of forming a third domain on a third region of a second substrate according to a second step of FIG. 17;

FIG. 20 is a plan view showing a third domain of FIG. 19;

FIG. 21 is a schematic cross-sectional view showing a method of forming a fourth domain on a fourth region of a second substrate according to a third step of FIG. 17;

FIG. 22 is a plan view showing a fourth domain of FIG. 21;

FIG. 23 is a schematic cross-sectional view showing a first substrate and a second substrate assembled together according to a fifth step of FIG. 9;

FIG. 24 is a perspective view showing a relation between first and third domains, and a relation between second and fourth domains according to a second exemplary embodiment of the present invention;

FIG. 25 is a perspective view showing a relation between first and third domains, and a relation between second and fourth domains according to another second exemplary embodiment of the present invention;

FIG. 26 is a schematic cross-sectional view showing a liquid crystal display apparatus having wide viewing angle according to a first exemplary embodiment of the present invention;

FIG. 27 is a schematic view showing a first electrode of FIG. 26;

FIG. 28 is a plan view showing first and second polarized functional groups formed on a first alignment film of a first substrate of FIG. 26;

FIG. 29 is a schematic cross-sectional view showing a liquid crystal display apparatus having wide viewing angle according to a second exemplary embodiment of the present invention;

FIG. 30 is a plan view showing a relation of first to fourth polarized functional groups of FIG. 29;

FIG. 31 is a plan view showing another relation of first to fourth polarized functional groups of FIG. 29;

FIG. 32 is a schematic view showing a liquid crystal alignment apparatus according to a first exemplary embodiment of the present invention;

FIG. 33 is a schematic view showing an angle adjuster for adjusting an irradiation angle of an atomic beam generated from an atomic beam generator of FIG. 32;

FIG. 34 is an atomic beam transmission unit of FIG. 32;

FIG. 35 is a schematic view showing a liquid crystal alignment apparatus having a mask supporter;

FIG. 36 is a plan view showing a mask supporter of FIG. 35 according to a first exemplary embodiment;

FIG. 37 is a schematic cross-sectional view showing a mask supporter of FIG. 36 aligned over an alignment film;

FIG. 38 is a plan view showing a mask supporter of FIG. 35 according to a second exemplary embodiment;

FIG. 39 is a schematic cross-sectional view showing a mask supporter of FIG. 38 aligned over an alignment film; and

FIG. 40 is a schematic cross-sectional view showing a liquid crystal alignment apparatus according to a second exemplary embodiment of the present invention.

### DESCRIPTION OF INVENTION

Hereinafter, the preferred embodiment of the present invention will be described in detail with reference to the accompanied drawings.

Embodiments of method of manufacturing multi-domain on alignment film by using atomic beam.

Embodiment 1

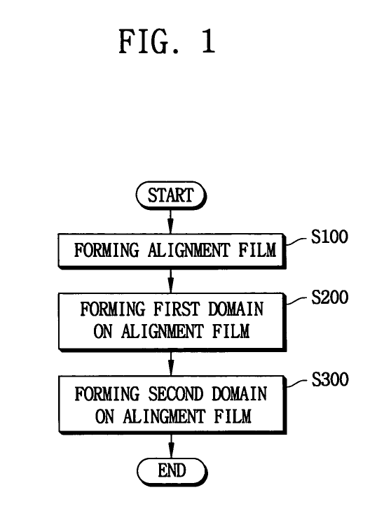

FIG. 1 is a flow chart showing a method of forming a multi-domain on an alignment film by atomic beam.

Referring to FIG. 1, an alignment film for a multi-domain is formed on a substrate by the atomic beam (step 100).

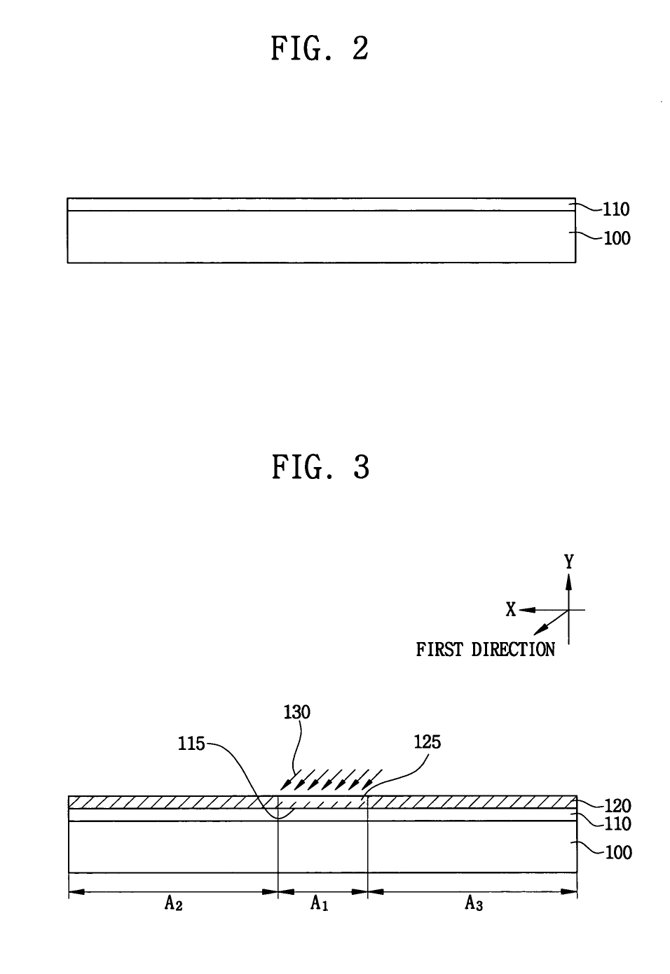

FIG. 2 is a schematic cross-sectional view showing an alignment film formed on a substrate according to a step 100 of FIG. 1.

Referring to FIG. 2, an alignment film 110 is formed on a substrate 100. The alignment film may comprise a material such as diamond-like-carbon (DLC), silicon oxide, silicon nitride, poly crystalline silicon, amorphous silicon, titanium oxide and polyimide.

For example, the diamond-like-carbon is preferably used as the alignment film 110.

Referring again to FIG. 1, after the alignment film is formed, a first domain is formed on a first region of the alignment film (step 200).

Only the first region of the alignment film is exposed to form the first domain thereon.

FIG. 3 is a schematic cross-sectional view showing a method of forming a first domain on a first region of an alignment film by a first mask according to a step 200 of FIG. 1.

Referring to FIGS. 2 and 3, a first mask 120 is formed on an alignment film 110. The first mask 120 has a first opening 125 to expose a first region A1. The first mask 120 covers a second region A2. The first and second regions A1 and A2 correspond to an entire region of the first mask 120.

The first mask 120 corresponds to a thin film deposited on the alignment film 110. For example, the thin film may include aluminum oxide (Al₂O₃). The thin film comprising the aluminum oxide (Al₂O₃) may be formed via a sputtering method or a chemical vapor deposition (CVD) process. The first mask 120 may includes a metal as a substitute of the aluminum oxide (Al₂O₃). Preferably, a thickness of the first mask 120 is no less than 1000 Å.

When the first mask 120 exposes the first region A1 of the alignment film 110, an atomic beam 130 is irradiated onto the first mask 120 in a first direction.

The first direction is in a range from about 0° to about 90° in a counterclockwise direction with respect to a negative y-axis.

The atomic beam 130 has a line shape. The atomic beam 130 scans the first mask 120. Thus, a portion of the atomic beam is irradiated onto the first area A1 of the alignment film 110 through the first opening 125 to form a first domain 115 for aligning liquid crystal molecules.

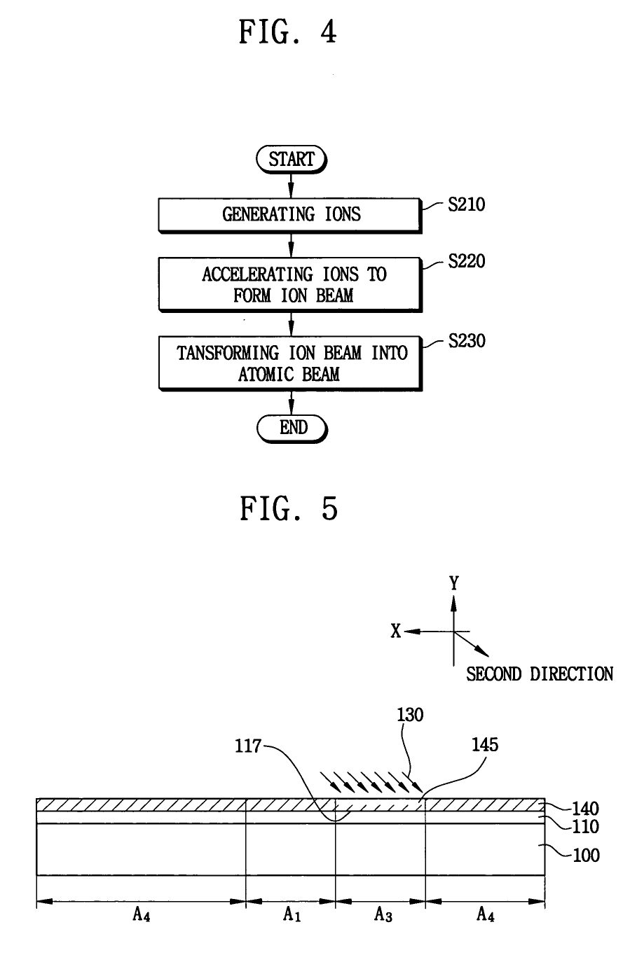

FIG. 4 is a flow chart showing a method of forming an atomic beam of steps 200 and 300 of FIG. 1.

Referring to FIGS. 3 and 4, a source gas is dissociated, so that ions are formed (step 210) so as to form an atomic beam.

Preferably, an inert gas is used as the source gas, because the inert gas has low reactivity. For example, an argon gas is used as the source gas. The argon gas is preferable to form the first domain, because the argon gas has heavy weight.

The argon gas may be heated to form the ions. When the argon gas is heated at a temperature above 2,500K, the argon is dissociated to form the ions. A tungsten (W) filament may heat the argon gas.

The argon gas may be allowed to pass through a space between an anode electrode and a cathode electrode to form the ions. Enough electric fields are formed between the cathode and anode electrodes. While passing through the space between the cathode and anode electrodes, electrons are dissociated from the argon gas, so that ions are formed.

When the ions are formed, an acceleration electrode attracts the ions, so that the ions are accelerated (step 220). The acceleration electrode has a mash-shape. The acceleration electrode has an opposite polarity to the ions. Thus, the ions are attracted toward the acceleration electrode to form an ion beam.

The ion beam combines with electrons, so that the ion beam is transformed into an atomic beam (step 230).

An electron beam intersects the ion beam. Thus, the ion beam is combined with electrons to be transformed into the atomic beam.

When the first domain A1 is formed, the first mask 120 is removed from the alignment film 110.

Referring again to FIG. 1, after the first domain is formed, a second domain is formed at a second region of the alignment film (step 300). The second region is adjacent to the first domain, but the second domain does not overlap with the first domain.

FIG. 5 is a schematic cross-sectional view showing a method of forming a second domain on a second region of an alignment film by a second mask according to a step 300 of FIG. 1.

Referring to FIG. 5, only a second region A3 of an alignment film 110 is exposed. The second region A3 is adjacent to a first region.

A second mask 140 is formed on the alignment film 110.

The second mask 140 corresponds to a thin film deposited on the alignment film 110. For example, the thin film may include aluminum oxide (Al₂O₃). The thin film comprising the aluminum oxide (Al₂O₃) may be formed via a sputtering method or a chemical vapor deposition (CVD) process. The second mask 140 may include a metal as a substitute of the aluminum oxide (Al₂O₃). Preferably, a thickness of the first mask 120 is no less than 1000 Å.

The second mask 140 is manufactured via the same process as the first mask 120. Thus, any further explanation will be omitted.

When the second mask 140 exposes the second region A2 of the alignment film 110, an atomic beam 130 is irradiated onto the second mask 140 in a second direction.

The second direction is in a range from about 0° to about 90° in a counterclockwise direction with respect to a negative y-axis.

The atomic beam 130 has a line shape. The atomic beam 130 scans the second mask 140. Thus, a portion of the atomic beam is irradiated onto the second region A3 of the alignment film 110 through the second opening 145 to form a second domain 117 for aligning liquid crystal molecules.

According to Embodiment 1, the atomic beam is irradiated onto more than one region of the alignment film to form a multi-domain by non-contacting method. Thus no additional process is needed to form the multi-domain on the alignment film.

Embodiment 2

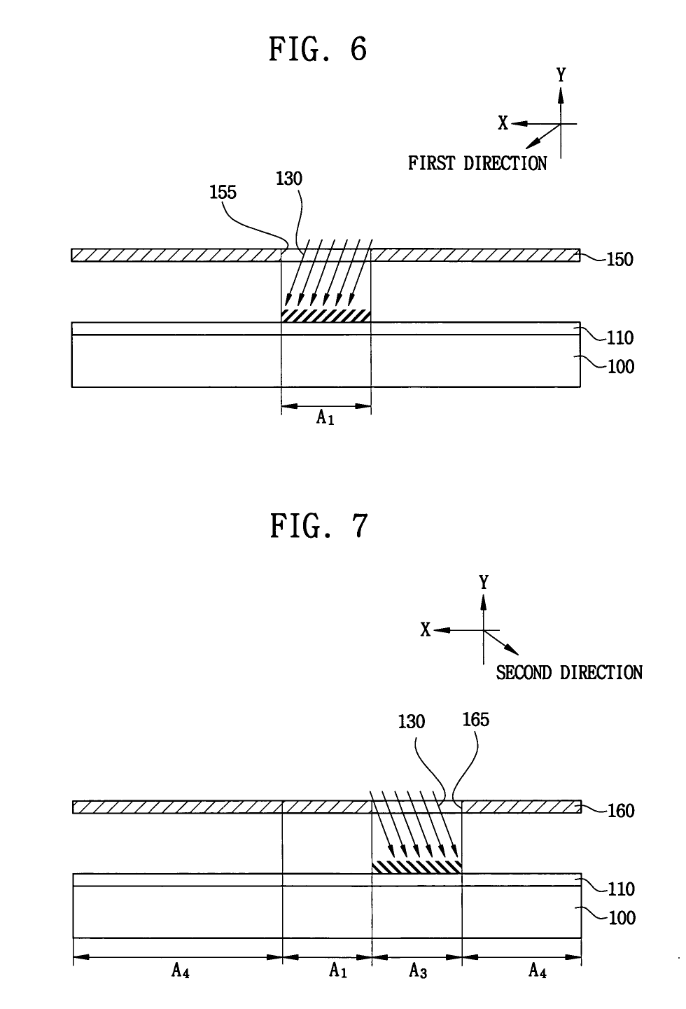

FIG. 6 is a schematic cross-sectional view showing a method of forming a first domain on a first region of an alignment film by a first floating mask according to a step 200 of FIG. 1, and FIG. 7 is a schematic cross-sectional view showing a method of forming a second domain on a second region of an alignment film by a second floating mask according to a step 300 of FIG. 1.

When an alignment film 110 is formed on a substrate 100 as shown in step 100 of FIG. 1, a first floating mask 150 is disposed over the alignment film 110, so that a first region A1 of the alignment film 110 is exposed.

The first floating mask 150 has a thin thickness. The first floating mask 150 has a plate-shape including a third opening 155. The third opening 155 corresponds to a first region A1 of the alignment film 110. The first floating mask 150 is spaced apart from the alignment film 110, such that the first floating mask 150 may move in a parallel direction with respect to the alignment film 110.

According to Embodiment 2, the first floating mask is spaced apart from the alignment film. Thus, process is simple, and a work speed is enhanced, so that embodiment 2 fits to a mass-producing.

When the first floating mask 150 exposes the first region A1 of the alignment film 110, an atomic beam 130 is irradiated onto the first mask 120 in a first direction.

The first direction is in a range from about 0° to about 90° in a clockwise direction with respect to a negative y-axis.

Referring to FIG. 7, a second floating mask 160 has a thin thickness. The second floating mask 160 has plate-shape including a fourth opening 165. The fourth opening 165 corresponds to a second region A3 of the alignment film 110. The second floating mask 160 is spaced apart from the alignment film 110, such that the second floating mask 160 may move in a parallel direction with respect to the alignment film 110.

When the second floating mask 160 exposes the second region A3 of the alignment film 110, an atomic beam 130 is irradiated onto the second floating mask 160 in a second direction.

The second direction is in a range from about 0° to about 90° in a counterclockwise direction with respect to a negative y-axis.

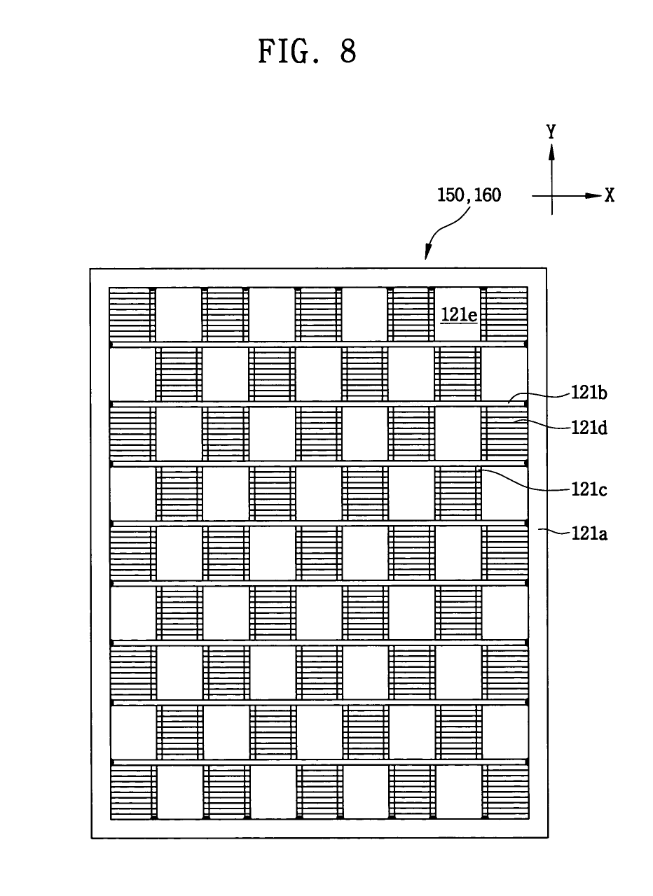

FIG. 8 is a plan view showing first and second floating masks of FIGS. 6 and 7.

First and second floating masks 150 and 160 have a thin thickness. When the thickness of the first and second floating masks 150 and 160 is thin, a portion onto which an atomic beam is irradiated is distorted.

Thus, the first and second floating masks 150 and 160 have a thin thickness.

Referring to FIG. 8, the first and second floating masks 150 and 160 include a support frame 121a, a first wire 121b, a second wire 121c and a third wire 121d.

The support frame 121a has a rectangular shape that has a substantially equal size and substantially equal shape with a substrate 100.

A first end of the first wire 121b is fixed at a first inner side of the support frame 121a. A second end of the first wire 121b is fixed at a second inner side of the support frame 121a. The first and second inner sides face each other.

Wires of which thickness is about 10 μm are twisted to form the first wire 121b. The first wire 121b is fixed tightly to the support frame 121a.

A first end of the second wire 121c is fixed at a third inner side of the support frame 121a. A second end of the second wire 121c is fixed at a fourth inner side of the support frame 121a. The third and fourth inner sides face each other.

Wires of which thickness is about 10 μm are twisted to form the second wire 121c. The second wire 121c is fixed tightly to the support frame 121a.

Thus, a plurality of the first wires 121b and a plurality of the second wire 121c are disposed to form a lattice shape. Therefore, windows 121e are defined by the first and second wires 121b and 121c.

Both ends of each of the third wires 121d are connected to the two neighboring second wires 121c, such that the third wires 121d block the window 121e. Thus, an atomic beam may not pass through the opening 121e. However, a portion of the openings 121e is not blocked by the third wires 121d, so that the atomic beam may pass through the opening 121e.

Both ends of the third wires 121d may be connected to the two neighboring first wires 121b.

The first and second floating masks 150 and 160 have thin thickness, and sagging of the masks is rare. Thus, the atomic beam may be irradiated onto a predetermined position.

According to Embodiment 2, the atomic beam is irradiated onto more than one region of the alignment film to form a multi-domain by non-contacting method. Thus no additional process is needed to form the multi-domain on the alignment film. Further, a time used for forming the multi-domain decreases.

Embodiments of a method of manufacturing a liquid crystal display apparatus having wide viewing angle.

Embodiment 1

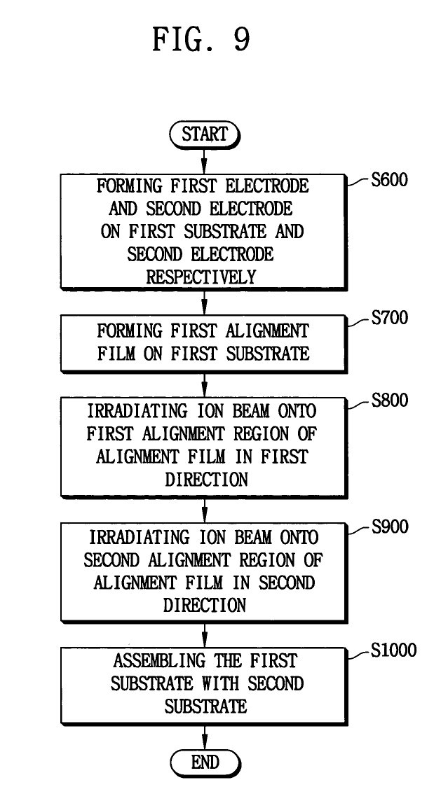

FIG. 9 is a flow chart showing a method of manufacturing a liquid crystal display apparatus having a wide viewing angle, according to a first exemplary embodiment of the present invention.

Referring to FIG. 9, first and second electrodes are formed on first and second substrates, respectively (step 600).

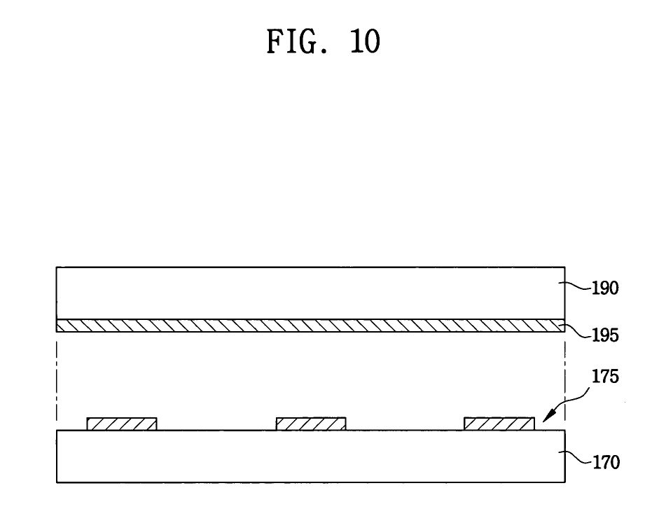

FIG. 10 is schematic cross-sectional view showing first and second substrates according to a step 600 of FIG. 9.

Referring to FIG. 10, a plurality of a first electrodes 175 is formed on a first substrate 170. The first electrodes 175 are arranged in a matrix shape.

For example, when a resolution of a liquid crystal display apparatus is 1024×768 and the liquid crystal display apparatus displays full color, a count of the liquid crystal display apparatus is 1024×768×3.

The first electrode 175 comprises indium tin oxide (ITO) or indium zinc oxide (IZO).

The second electrode 195 is formed on the second substrate 190, such that the second electrode 195 covers an upper face of the second substrate 190.

The second electrode 195 comprises indium tin oxide (ITO) or indium zinc oxide (IZO).

Referring again to FIG. 9, when the first and second substrates are formed on the first and second substrates respectively (step 600), a first alignment film is formed on the first substrate (step 700).

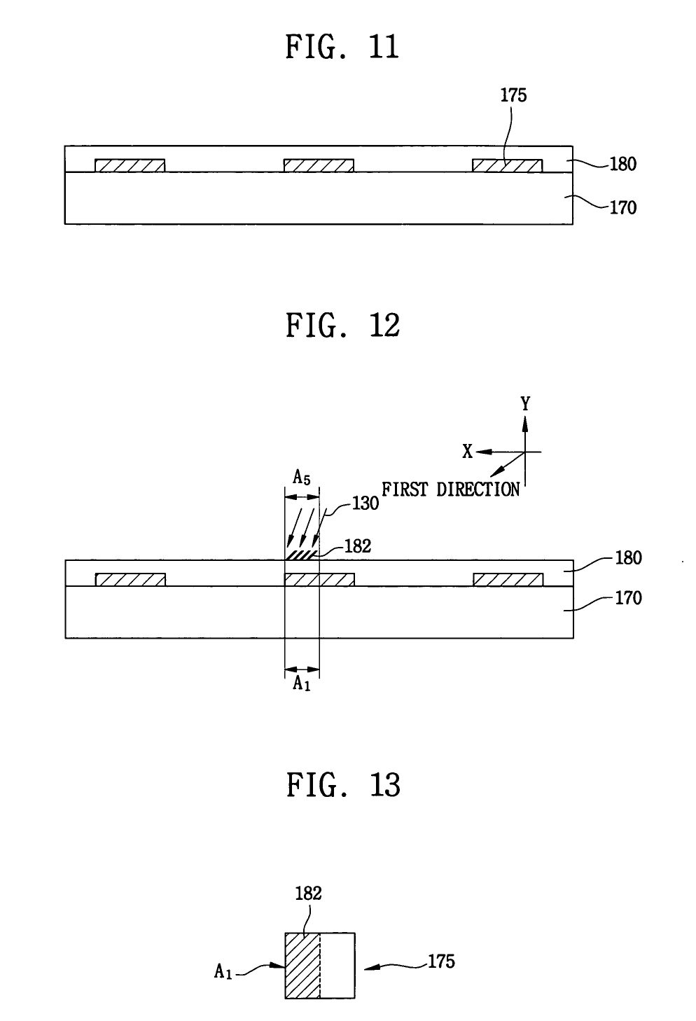

FIG. 11 is a schematic cross-sectional view showing an alignment film formed on a first substrate having a first electrode formed thereon according to a step 700 of FIG. 9.

Referring to FIG. 11, a first alignment film 180 is formed on a first substrate 170 having a first electrode 175 formed thereon. The first alignment film 180 may comprise a material such as diamond-like-carbon (DLC), silicon oxide, silicon nitride, poly-silicon, amorphous-silicon, titanium oxide and polyimide.

For example, the first alignment film 180 comprises the diamond-like-carbon. The first alignment film 180 may be formed on the first substrate 170 by a chemical vapor deposition (CVD) process.

Referring again to FIG. 9, when the first alignment film is formed on the first substrate (step 700), an atomic beam is irradiated onto a first alignment region of the first alignment film in a first direction (step 800).

FIG. 12 is a schematic cross-sectional view showing a method of forming a first domain on a first region of an alignment film according to a step 800 of FIG. 9, and FIG. 13 is a plan view showing a first domain of FIG. 12.

Referring to FIGS. 12 and 13, only a first alignment region A5 of the first alignment film is exposed. The first alignment region A5 corresponds to a first region A1 of the first electrode 175 formed on the first substrate 170. An atomic beam 130 is irradiated onto the first alignment region A5 in a first direction to form a first domain 182. The first direction is in a range from about 0° to about 90° in a clockwise direction with respect to a negative y-axis.

More than one first region A1 may be formed on the first electrode 175.

Referring again to FIG. 9, when the atomic beam is irradiated onto the first alignment region in the first direction (step 800), the atomic beam is irradiated onto the second alignment region in a second direction (step 900).

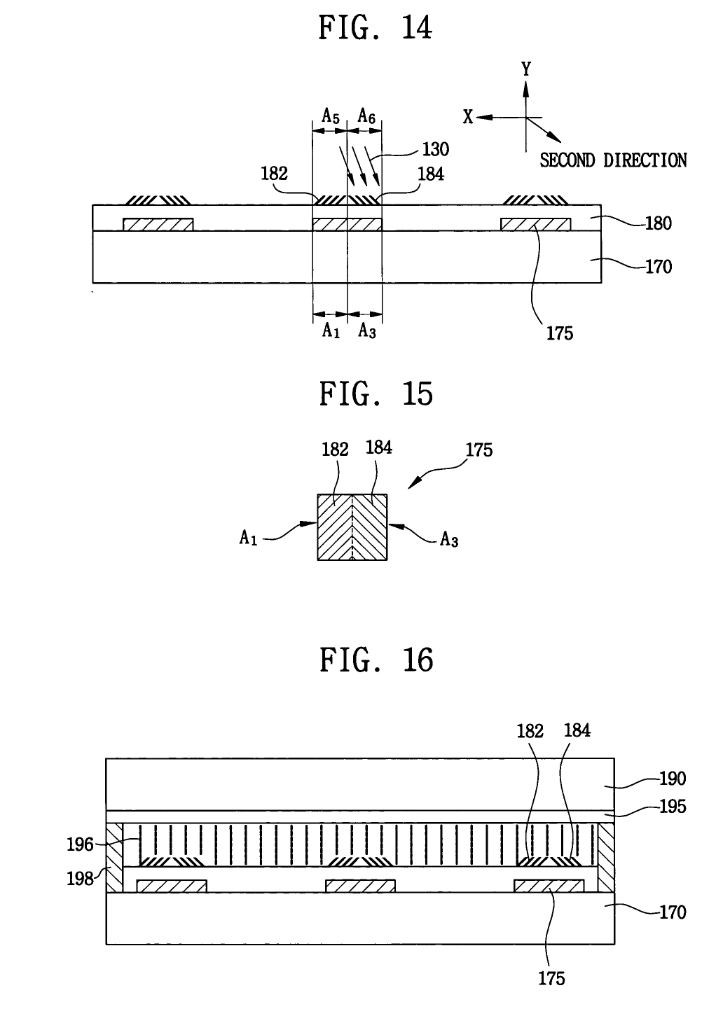

FIG. 14 is a schematic cross-sectional view showing a method of forming a second domain on a second region of an alignment film according to a step 900 of FIG. 9, and FIG. 15 is a plan view showing a second domain of FIG. 14.

Referring to FIGS. 14 and 15, only a second alignment region A6 of a first alignment film 180 is exposed. The second alignment region A6 corresponds to a second region A3 of the first electrode 175. An atomic beam 130 is irradiated onto the second alignment region A6 is a second direction to form a second domain 184 of the second alignment region A6. The second direction is in a range from about 0° to about 90° in a counterclockwise direction with respect to a negative y-axis.

More than one second region A3 may be formed on the first electrode 175.

When more than one first region A1 and the second region A3 are formed on the first electrode 175, the first region A1 alternates with the second region A3 preferably.

Referring to again FIG. 9, the first and second substrates are assembled together (step 1000). A liquid crystal layer is interposed between the first and second substrates. A liquid crystal material may be injected between the first and second substrates to form the liquid crystal layer after or before the first and second substrates are combined with each other.

FIG. 16 is a schematic cross-sectional view showing first and second substrates assembled together according to a step 1000 of FIG. 9.

Referring to FIG. 16, a sealant 198 is interposed between first and second substrates 170 and 190 so as to assemble the first and second substrates 170 and 190. The sealant 198 is disposed along an edge portion of the first and second substrates 170 and 190.

The sealant 198 connects the first substrate 170 to the second substrate 190. The sealant 198 is disposed along edges of the first and second substrates 170 and 190. The sealant 198 glues the first and second substrates 170 and 190 together, and the sealant 198 seals a liquid crystal 196 in-between the substrates.

According to Embodiment 1 of a method of manufacturing a liquid crystal display apparatus having a wide viewing angle, an atomic beam is irradiated onto the first region and the second region in the first and second directions respectively to form the first and second domains by non-contacting method.

Embodiment 2

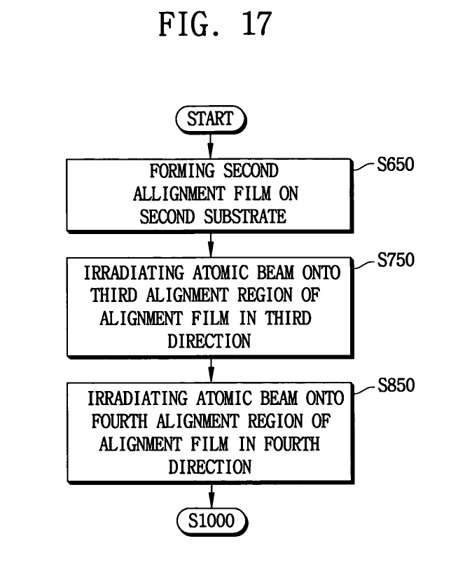

FIG. 17 is a flow chart showing a method of manufacturing a liquid crystal display apparatus having wide viewing angle, according to a second exemplary embodiment of the present invention. In the present embodiment, a method of forming a second domain is the same as in a method of forming the first domain described in step 600—step 900 of FIG. 9. Thus, any further explanation concerning the method of forming the second domain will be omitted.

Referring to FIG. 17, a second alignment film is formed on a second substrate (step 650), before assembling the first substrate with the second substrate (step 1000 of FIG. 9).

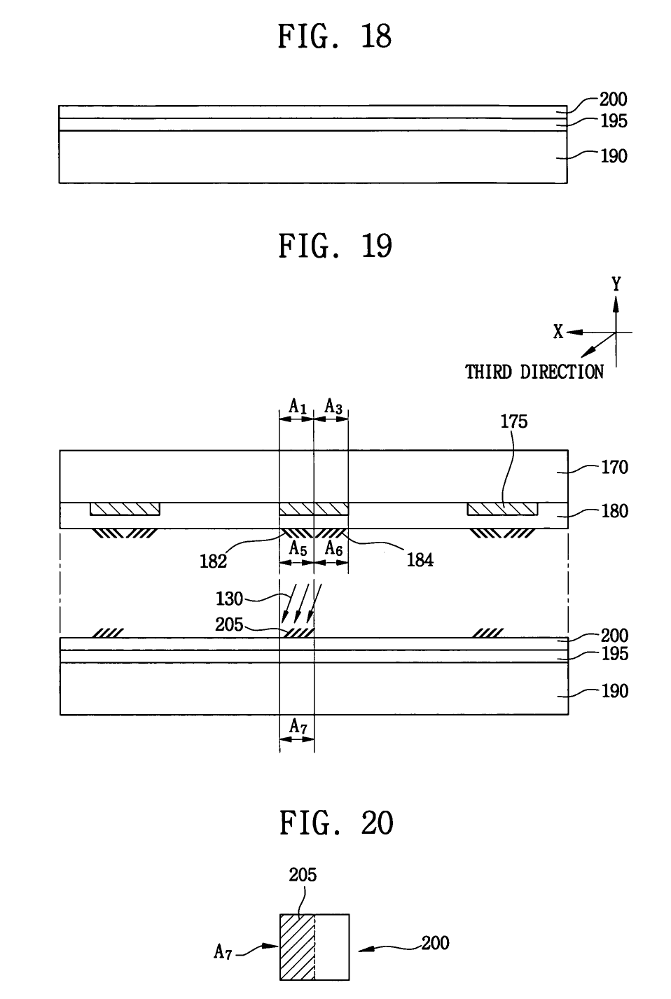

FIG. 18 is a schematic cross-sectional view showing a second alignment film formed on a second electrode of a second substrate according to a step 650 of FIG. 17.

Referring to FIG. 18, a second electrode 195 is formed on a second substrate 190 to cover an upper face of the second substrate 190. The second electrode 195 comprises indium tin oxide (ITO) or indium zinc oxide (IZO).

A second alignment film 200 is formed on the second electrode 195 to cover the second electrode 195. The second alignment film 200 may comprise a material such as diamond-like-carbon (DLC), silicon oxide, silicon nitride, poly crystalline silicon, amorphous silicon, titanium oxide, polyimide, etc. For example, the second alignment film 200 comprises the diamond-like-carbon (DLC).

Referring again to FIG. 17, when the second alignment film is formed on the second substrate (step 650), an atomic beam is irradiated onto a third alignment region of the second alignment film in a third direction (step 750). The third alignment region faces the first alignment region.

FIG. 19 is a schematic cross-sectional view showing a method of forming a third domain on a third region of a second substrate according to a step 750 of FIG. 17, and FIG. 20 is a plan view showing a third domain of FIG. 19.

Referring to FIGS. 19 and 20, a third alignment region A7 is formed on a second alignment film 200, such that the third alignment region A7 faces a first alignment region A5. An atomic beam is irradiated onto the third alignment region A7 in a third direction, so that a third domain 205 is formed on the third alignment region A7 in the third direction.

Referring again to FIG. 17, when the atomic beam is irradiated onto the third alignment region (step 750), the atomic beam is irradiated onto a fourth alignment region that faces a second alignment region in a fourth direction (step 850).

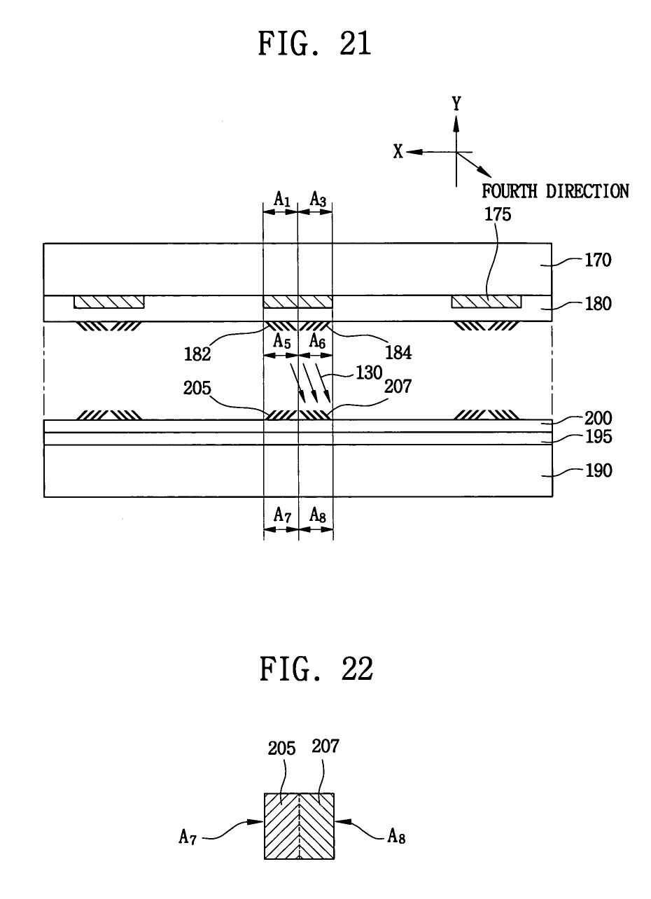

FIG. 21 is a schematic cross-sectional view showing a method of forming a fourth domain on a fourth region of a second substrate according to a step 850 of FIG. 17, and FIG. 22 is a plan view showing a fourth domain of FIG. 21.

Referring to FIGS. 21 and 22, a fourth alignment region A8 is formed on a second alignment film 200, such that the fourth alignment region A8 faces a second alignment region A6. Only the fourth alignment region A8 is exposed. An atomic beam 130 is irradiated onto the fourth alignment region A8 in a fourth direction.

Thus, a fourth domain 207 is formed on the fourth alignment region A8 of the second alignment film 190 in the fourth direction.

Then, the first and second substrates 170 and 190 are assembled together. A liquid crystal material is provided between the first and second substrates 170 and 190.

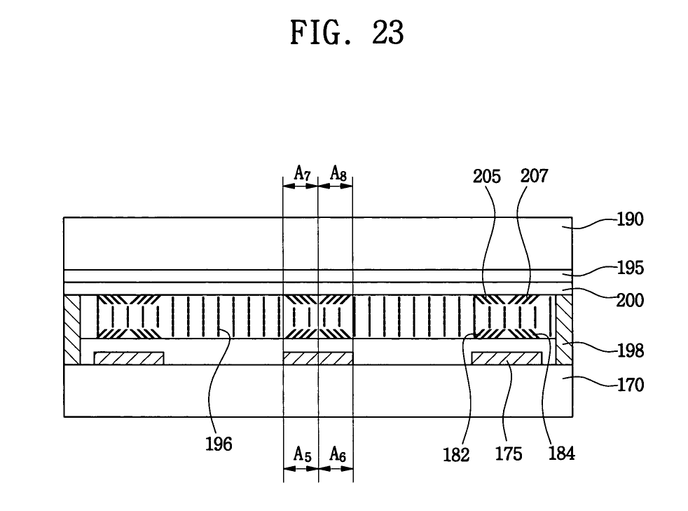

FIG. 23 is a schematic cross-sectional view showing a first substrate and a second substrate assembled together according to a step 1000 of FIG. 9.

Referring to FIG. 23, a sealant 198 is disposed between first and second substrates 170 and 190 so as to assemble the first and second substrates 170 and 190 with each other. The sealant 198 is disposed along an edge of the first and second substrates 170 and 190. The sealant 198 connects the first and second substrates 170 and 190 to each other. The sealant 198 prevents a liquid crystal material from being leaked.

An arrangement of a liquid crystal molecule of the liquid crystal material is adjusted according to an aligning direction of a first domain 182 of a first substrate 170 and a third domain 205 of a second substrate 190, and the liquid crystal molecule is also adjusted according the aligning direction of a second domain 184 of the first substrate 170 and a fourth domain 207 of the second substrate 190.

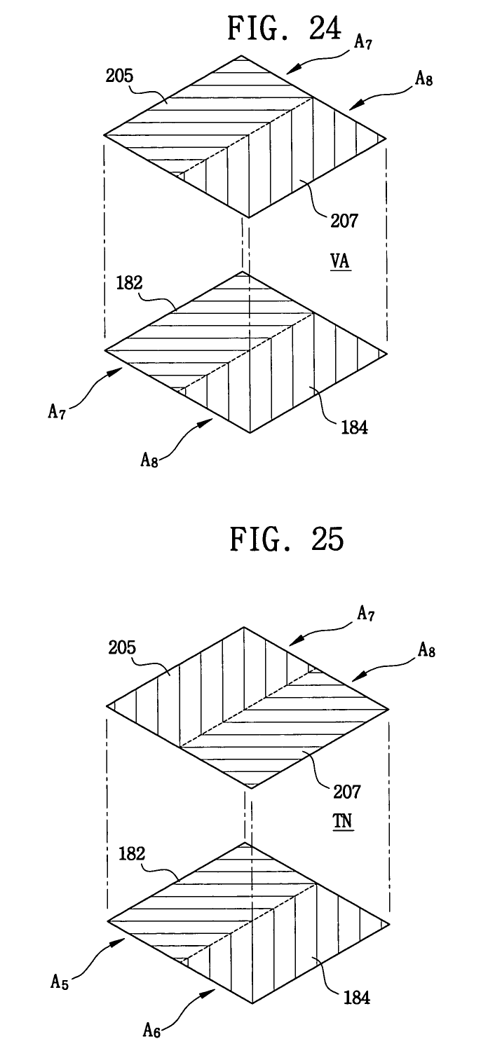

FIG. 24 is a perspective view showing a relation between first and third domains, and a relation between second and fourth domains according to a second exemplary embodiment of the present invention.

Referring to FIGS. 23 and 24, an aligning direction of a first domain 182 of a first aligning region A5 is substantially in parallel with the aligning direction of a third domain 205 of a third aligning region A7. The aligning direction of a second domain 184 of a second aligning region A6 is substantially in parallel with the aligning direction of a fourth domain 207 of a fourth aligning region A8.

Liquid crystal material is interposed between the first substrate 170 and the second substrate 190. Then, liquid crystal molecules are vertically aligned with respect to the first and second substrates 170 and 190. Thus, a liquid crystal display apparatus having the vertically aligned liquid crystal is referred to as ‘vertically alignment (VA) mode liquid crystal display apparatus’.

FIG. 25 is a perspective view showing a relation between first and third domains, and a relation between second and fourth domains according to another second exemplary embodiment of the present invention.

Referring to FIGS. 23 and 25, an aligning direction of a first domain 182 is different from the aligning direction of a third domain 205. For example, the aligning direction of the first domain 182 forms an angle with reference to the aligning direction of the third domain 205, such that the angle is in a range from about 90° to about 270°.

The aligning direction of a second domain 184 is different from the aligning direction of a fourth domain 207. For example, the aligning direction of the second domain 184 forms an angle with reference to the aligning direction of the fourth domain 207, such that the angle is in a range from about 90° to about 270°.

A liquid crystal material is interposed between the first substrate 170 and the second substrate 190. Then, liquid crystal molecules are twisted to form a helical shape. Thus, a liquid crystal display apparatus having the twisted liquid crystal is referred to as ‘twisted nematic mode or super twisted nematic mode liquid crystal display apparatus’.

Liquid crystal display apparatus having wide viewing angle.

Embodiment 1

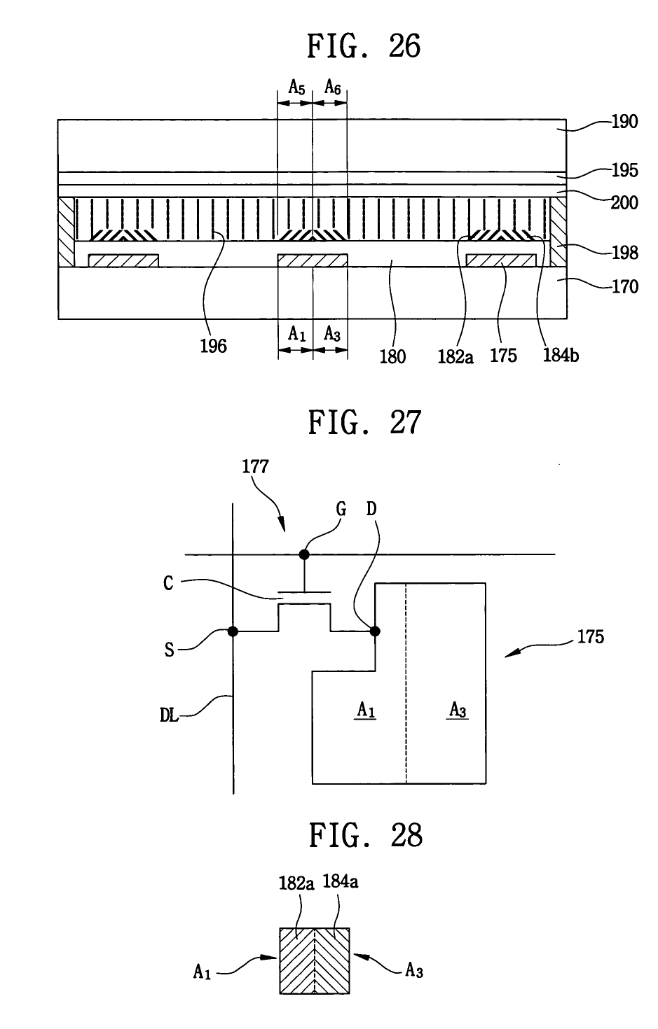

FIG. 26 is a schematic cross-sectional view showing a liquid crystal display apparatus having wide viewing angle according to a first exemplary embodiment of the present invention.

Referring to FIG. 26, a liquid crystal display apparatus 230 includes first and second substrates 170 and 190, first and second electrodes 175 and 195, first and second alignment films 180 and 200, and liquid crystal 196. The liquid crystal display apparatus 230 has a wide viewing angle.

The first electrode 175 is formed on the first substrate 170. The first alignment film 180 is formed on the first substrate 170 to cover the first electrode 175.

The second electrode 195 is formed on the second substrate 190. The second alignment film 200 is formed on the second electrode 195.

However, the first and second electrodes 175 and 195 may alternate with each other in a same substrate.

A plurality of the first electrodes 175 is disposed on the first substrate 179, such that the first electrodes 175 are arranged in a matrix shape.

Each of the first electrodes 175 comprises indium tin oxide (ITO) or indium zinc oxide (IZO). The indium tin oxide and the indium zinc oxide are electrically conductive, and transparent.

FIG. 27 is a schematic view showing a first electrode of FIG. 26.

Referring to FIG. 27, a first electrode 175 may include at least one first region A1 and at least one second region A3. The number of the first region A1 is identical with the number of the second region A3. For example, the first electrode 175 includes one first region A1. Then, the number of the second region A3 that the first electrode 175 includes has to be also one. When the count of the first and second region A1 and A3 is plural, the first and second regions A1 and A3 alternate with each other.

The first electrode 175 is electrically connected to a thin film transistor 177.

The thin film transistor 177 includes a gate electrode G, a drain electrode D, a source electrode S and a channel layer C. The gate electrode G is electrically connected to a gate line GL. The source electrode S is electrically connected to a data line DL. The drain electrode D is electrically connected to the first electrode 175.

FIG. 28 is a plan view showing first and second polarized functional groups formed on a first alignment film of a first substrate of FIG. 26.

Referring again to FIGS. 26 and 28, the first alignment film 180 is formed on the first substrate 170, such that the first alignment film 180 covers the first electrode 175.

The first alignment film 180 may comprise a material such as diamond-like-carbon (DLC), silicon oxide, silicon nitride, poly crystalline silicon, amorphous silicon, titanium oxide and polyimide. For example, the diamond-like-carbon is preferably used as the first alignment film 180.

A first alignment region A5 of the first alignment film 180 is disposed over the first region A1 of the first electrode 175. A second alignment region A6 of the first alignment film 180 is disposed over the second region A2 of the first electrode 175.

A first polarized functional group 182a for aligning liquid crystal molecule is formed on the first alignment region A5 by a non-contacting method. A second polarized functional group 184a for aligning liquid crystal molecule is formed on the second alignment region A6 by the non-contacting method.

An atomic beam forms the first and second polarized functional groups 182a and 184a.

A method of forming the first and second polarized functional groups 182a and 184a is described in Korea Patent Application No. 2002-69467 (entitled “Method and Apparatus for aligning liquid crystal”). Thus, detailed explanation is omitted.

The first polarized functional group 182a is formed on the first alignment region A5 in a first direction. The second polarized functional group 184a is formed on the second alignment region A6 in a second direction. The first and second directions are different from each other.

A second electrode 195 is formed on the second substrate 190. A second alignment film 200 is formed on the second electrode 195.

The first and second substrates 170 and 190 are assembled together, such that the first and second substrates 170 and 190 face each other.

The first substrate 170 is spaced apart from the second substrate 190 by a few micrometers (μm).

A sealant 198 is formed along an edge of the first and second substrates 170 and 190. Then, a liquid crystal material is disposed and sealed up between the first and second substrates 170 and 190.

Embodiment 2

In Embodiment 2, only a second substrate is different from that of Embodiment 1. Thus, an explanation concerning the same elements will be omitted.

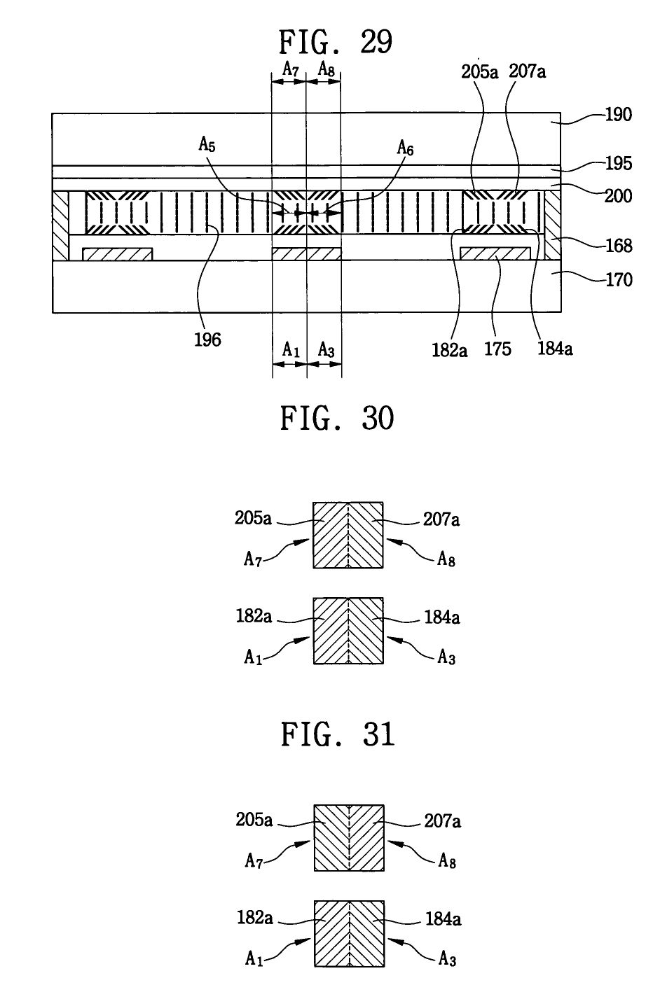

FIG. 29 is a schematic cross-sectional view showing a liquid crystal display apparatus having wide viewing angle according to a second exemplary embodiment of the present invention.

Referring to FIG. 29, a second substrate 190 includes a second electrode 195 and a second alignment film 200. The second electrode 195 is formed on the second substrate 190 to cover a face of the second substrate 190. The second electrode 195 of the second substrate 190 faces a first electrode 175 of a first substrate 170.

The second alignment film 200 includes a third alignment region A7 and a fourth alignment region A8. The third alignment region A7 faces a first region A1 of the first electrode 175. An area of the third alignment region A7 is substantially same with the first alignment region A1.

The fourth alignment region A8 faces a second region A3 of the first electrode 175. An area of the fourth alignment region A8 is substantially the same as in the second alignment region A3.

A third polarized functional group 205a is formed on the third alignment region A7 by an atomic beam irradiated in a third direction. A fourth polarized functional group 207a is formed on the fourth alignment region A8 by the atomic beam irradiated in a fourth direction.

FIG. 30 is a plan view showing a relation of first to fourth polarized functional groups of FIG. 29.

Referring to FIGS. 29 and 30, a first polarized functional group 182a is formed on a first alignment region A1. A third polarized functional group 205a is formed on a third alignment region A7. A direction of the first polarized functional group 182a is substantially parallel with the direction of the third polarized functional group 205a.

A second polarized functional group 184a is formed on a second alignment region A3. A fourth polarized functional group 207a is formed on a fourth alignment region A8. A direction of the second polarized functional group 184a is substantially parallel with the direction of the fourth polarized functional group 207a. However the direction of the first polarized functional group 182a is not in parallel with the direction of the second polarized functional group 184a.

A liquid crystal material is interposed between the first alignment film 180 and the second alignment film 200. Then, liquid crystal molecules are vertically aligned with respect to the first and second alignment films 180 and 200. Thus, a liquid crystal display apparatus having the vertically aligned liquid crystal is referred to as ‘vertically alignment (VA) mode liquid crystal display apparatus’.

FIG. 31 is a plan view showing another relation of first to fourth polarized functional groups of FIG. 29.

Referring to FIGS. 29 and 31, a first polarized functional group 182a is formed on a first alignment region A1. A third polarized functional group 205a is formed on a third alignment region A7. A direction of the first polarized functional group 182a is different from the direction of the third polarized functional group 205a. For example, the direction of the first polarized functional group 182a forms an angle with reference to the direction of the third polarized functional group 205a, such that the angle is in a range from about 90° to about 270°.

A second polarized functional group 184a is formed on a second alignment region A3. A fourth polarized functional group 207a is formed on a fourth alignment region A8. A direction of the second polarized functional group 184a is different from the direction of the fourth polarized functional group 207a. For example, the direction of the second polarized functional group 184a forms an angle with reference to the direction of the fourth polarized functional group 207a, such that the angle is in a range from about 90° to about 270°.

A liquid crystal material is interposed between the first and second alignment films 180 and 200. Then, liquid crystal molecules are twisted to form a helical shape. Thus, a liquid crystal display apparatus having the twisted liquid crystal is referred to as ‘twisted nematic mode or super twisted nematic mode liquid crystal display apparatus’.

Embodiments of a liquid crystal alignment apparatus.

Embodiment 1

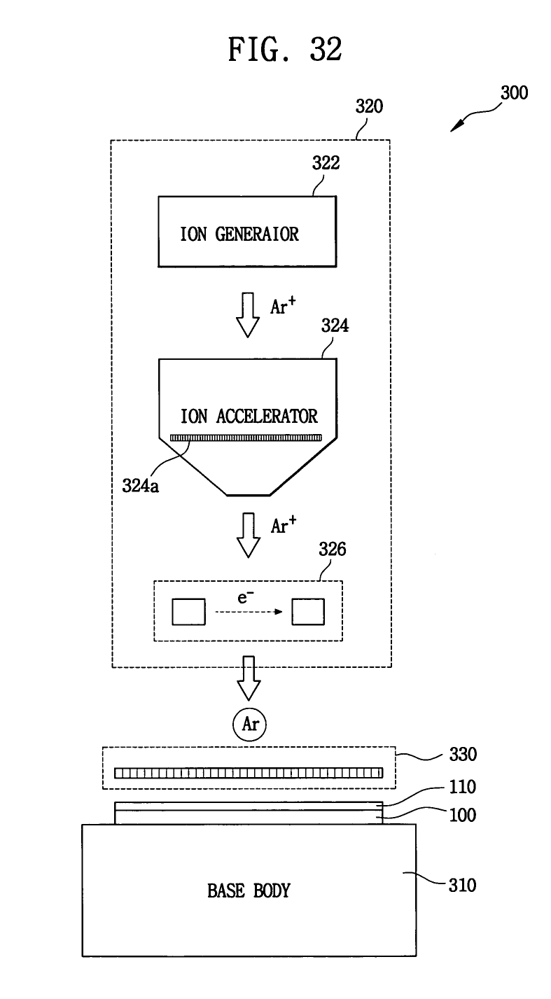

FIG. 32 is a schematic view showing a liquid crystal alignment apparatus according to a first exemplary embodiment of the present invention.

Referring to FIG. 32, a liquid crystal alignment apparatus 300 includes a base body 310, an atomic beam generator 320 and an atomic beam blocking unit 330.

The atomic beam generator 320 is disposed over the base body 310. The atomic beam blocking unit 330 is disposed between the atomic beam generator 320 and the base body 310.

The base body 310 supports a substrate 100 having an alignment film 110 formed thereon.

The atomic beam generator 320 includes an ion generator 322, an ion accelerator 324 and a neutralizer 326.

The ion generator 322 dissociates source gas. For example the ion generator 322 dissociates argon gas into argon ions.

The ion generator 322 may include a tungsten (W) filament (not shown) and a power supply (not shown). The power supply provides the tungsten filament with a power, so that the tungsten filament heats the argon gas. Thus, electrons are separated from the argon gas, so that the argon ions are formed.

The ion generator 322 may include an anode electrode and a cathode electrode. When an enough electric field is formed between the anode electrode and the cathode electrode, an electron is dissociated from the argon gas, so that argon ions are formed.

The ion accelerator 324 includes an acceleration electrode 324a. The acceleration electrode 324a has a mesh-shape. A negative voltage is applied to the acceleration electrode 324a, so that argon ions are attracted by the acceleration electrode 324a. Thus, the argon ions are accelerated toward the acceleration electrode 324a to form an ionic beam. While the ionic beam passes through the acceleration electrode 324a, a cross-sectional shape of the ionic beam is adjusted to have a line shape.

The neutralizer 326 is disposed near the acceleration electrode 324a. The neutralizer 326 transforms the ionic beam into an atomic beam. The neutralizer 326 provides the ionic beam with electrons, so that the ions of the ionic beam recombines with the electrons. Thus, the atomic beam is formed.

When the distance between the neutralizer 326 and the acceleration electrode 324a is long, the ionic beam that passes though the acceleration electrode 324a is attracted reverse toward the acceleration electrode 324a. Thus, the neutralizer 326 is disposed as nearest to the acceleration electrode 324a as possible.

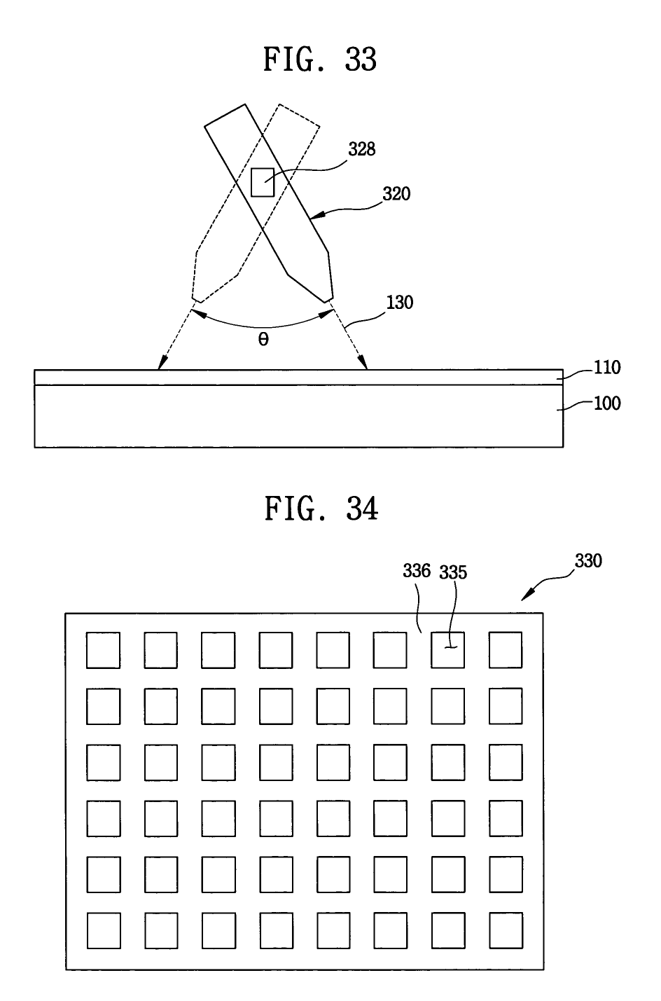

FIG. 33 is a schematic view showing an angle adjuster for adjusting an irradiation angle of an atomic beam generated from an atomic beam generator of FIG. 32.

Referring to FIG. 33, the atomic beam generator 320 further includes an angle adjuster 328. The angle adjuster 328 adjusts an irradiation angle formed by the atomic beam with respect to an alignment film 110. The angle adjuster 328 may rotate in an angle θ.

Referring again to FIG. 32, the atomic beam is irradiated onto a predetermined position of the alignment film 110 selectively via the atomic beam blocking unit 330.

FIG. 34 is an atomic beam transmission unit of FIG. 32.

Referring to FIGS. 32 and 34, the atomic beam blocking unit 330 includes an atomic beam mask 336. The atomic beam mask 336 includes a plurality of openings 335.

The atomic beam mask 336 allows an atomic beam to irradiate onto a predetermined position. That is, only an atomic beam may pass through the atomic beam blocking unit 330 via the openings 335.

As the atomic beam mask 336 becomes thinner, the atomic beam is irradiated onto the predetermined position accurately.

However, as the atomic beam mask 336 becomes thinner, the atomic beam mask 336 sags due to a self-weight. When the atomic beam mask 336 goes to sagging, a position of the opening 335 is changed, so that the atomic beam is deviated from the predetermined position. Thus, the liquid crystal display device becomes deteriorated.

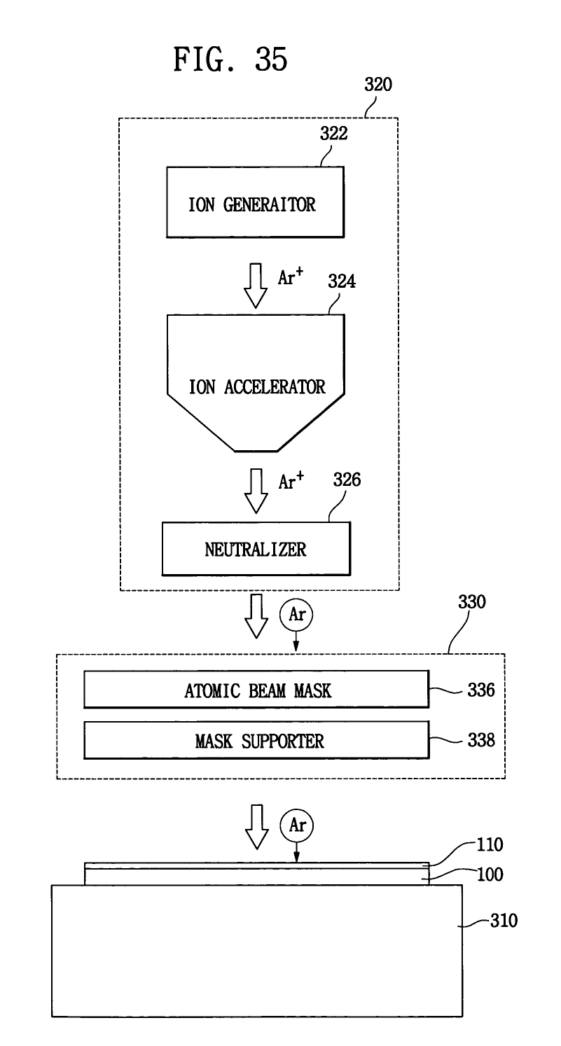

FIG. 35 is a schematic view showing a liquid crystal alignment apparatus having a mask supporter.

Referring to FIGS. 34 and 35, a mask supporter 338 is disposed under an atomic beam mask 330 so as to support the atomic beam mask 330. The mask supporter 338 does not block an atomic beam.

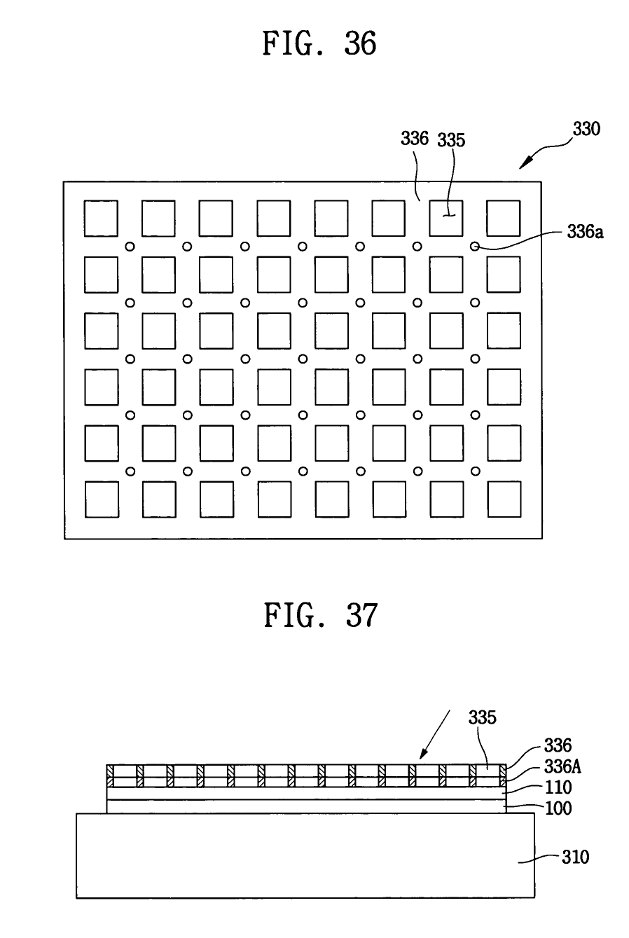

FIG. 36 is a plan view showing a mask supporter of FIG. 35 according to a first exemplary embodiment.

Referring to FIG. 36, a mask supporter 336a corresponds to a protrusion. A plurality of protrusions is formed on one face of the mask supporter 336a. Each of the protrusion is disposed between openings 335.

FIG. 37 is a schematic cross-sectional view showing a mask supporter of FIG. 36 aligned over an alignment film.

Referring to FIG. 37, a first end of a protrusion is connected to an atomic beam mask 336. A second end of the protrusion makes contact with an alignment film 110, so that the atomic beam mask 336 maintains a uniform distance from the alignment film 110.

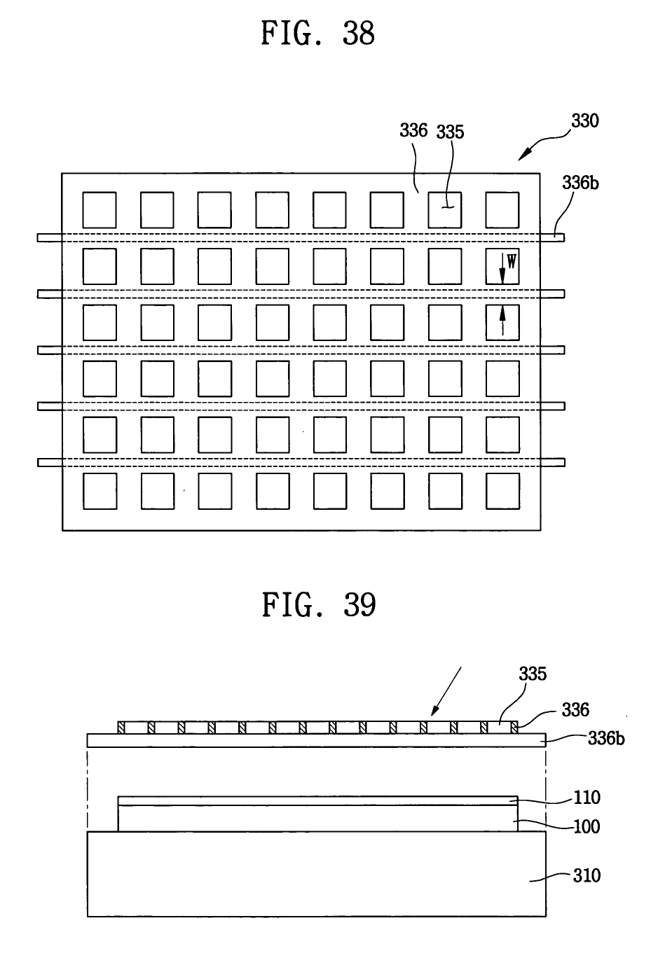

FIG. 38 is a plan view showing a mask supporter of FIG. 35 according to a second exemplary embodiment, and FIG. 39 is a schematic cross-sectional view showing a mask supporter of FIG. 38 aligned over an alignment film.

Referring to FIGS. 38 and 39, a mask supporter 336b corresponds to a quartz bar or a support wire. A width of the mask supporter 336b is narrower than a distance between the openings 335. The mask supporter 336b is extended between the openings 335 so that the mask supporter 336b is not exposed via the opening 335.

The mask supporter 336b is interposed between an atomic beam mask 336 and an alignment film 110, so that the mask supporter 336b supports the atomic beam mask 336.

An atomic beam scans the atomic beam mask 336 in an inclined direction.

Thus, when a scan direction of the atomic beam is different from a longitudinal direction of the mask supporter 336b, a portion of the mask supporter 336b blocks the atomic beam. Therefore, preferably the mask supporter 336b is disposed under the atomic beam mask 336, such that the direction of the mask supporter 336b is in parallel with the scan direction of the atomic beam.

According to present embodiment, multi-domain may be formed at predetermined position accurately by a non-contacting method.

Embodiment 2

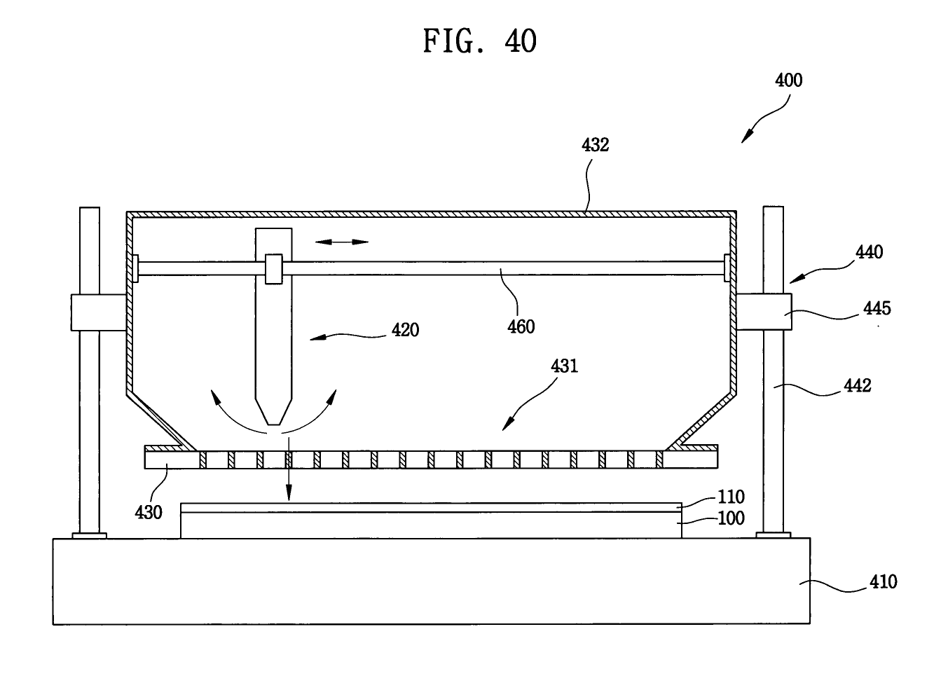

FIG. 40 is a schematic cross-sectional view showing a liquid crystal alignment apparatus according to a second exemplary embodiment of the present invention.

Only a cover of an atomic beam generator and a lift unit are different in comparison with Embodiment 1. Thus, any further explanation of the same elements will be omitted.

Referring to FIG. 40, a liquid crystal alignment device 300 includes a base body 410, an atomic beam generator 420, a cover 432 of an atomic beam generator 420, an atomic beam blocking unit 430 and a lift unit 440.

The lift unit 440 is disposed over the base body 410. The lift unit 440 includes a lift bar 442 and a lift body 445. The lift bar 442 is erected, so that a longitudinal direction of the lift bar 442 is substantially perpendicular to an upper face of a base body 410. The lift body 445 may move in a vertical direction along the lift bar 442.

The cover 432 is connected with the lift body 445. Thus, when the lift body 445 moves along the lift bar 442, the cover 432 moves vertically also along the lift bar 442.

The cover 432 includes opening 431, such that an atomic beam generated form the atomic beam generator 420 may pass through the opening 431 to arrive at an alignment film 110.

A transferring bar 460 is equipped inside the cover 432. A longitudinal direction of the transferring bar 460 is substantially parallel to the alignment film 110.

The atomic beam generator 420 is connected to the transferring bar 460, such that the atomic beam generator 420 may move in parallel with the alignment film 110 along the transferring bar 460.

An atomic beam blocking unit 430 is attached to cover the opening 431.

According to Embodiment 2, the liquid crystal alignment apparatus may form a plurality of domains by a non-contacting method.

Having described the exemplary embodiments of the present invention and its advantages, it is noted that various changes, substitutions and alterations can be made herein without departing from the spirit and scope of the invention as defined by appended claims.

What is claimed is:

1. A method of forming a multi-domain for aligning liquid crystal, comprising:
forming an alignment film on a substrate;
scanning the alignment film with an atomic beam irradiated in a first direction to form a first domain in a first region of the first alignment film; and
scanning the alignment film with the atomic beam irradiated in a second direction to form a second domain in a second region of the first alignment film.

2. The method of claim 1, wherein the alignment film comprises a material selected from the group consisting of diamond-like-carbon (DLC), silicon oxide, silicon nitride, poly crystalline silicon, amorphous silicon, titanium oxide and polyimide.

3. The method of claim 1, wherein the atomic beam is irradiated only in the first region of the first alignment film via a first mask having a first opening that exposes the first region.

4. The method of claim 3, wherein the first mask makes contact with a surface of the first alignment film.

5. The method of claim 4, wherein the first mask corresponds to an aluminum oxide (Al₂O₃) layer coated on the first alignment film.

6. The method of claim 1, wherein the atomic beam is irradiated only in the second region of the first alignment film via a second mask having a second opening that exposes the second region.

7. The method of claim 6, wherein the second mask makes contact with a surface of the first alignment film.

8. The method of claim 7, wherein the second mask corresponds to an aluminum oxide (Al₂O₃) layer coated on the first alignment film.

9. The method of claim 1, wherein the atomic beam is formed by:
dissociating atoms to transform the atoms into ions;
accelerating the ions to form an ionic beam; and
neutralizing the ionic beam to transform the ionic beam into an atomic beam.

10. The method of claim 1, wherein the atomic beam is irradiated only in the first region of the first alignment film via a first floating mask having a third opening that exposes the first region, the first floating mask being disposed over the first alignment film.

11. The method of claim 10, wherein the first floating mask comprises a support frame, and a plurality of first, second and third wires, the support frame having an opening at a center portion of the support frame, each of the first wires being extended in a first direction in the opening, both ends of each of the first wires being connected to an inner wall of the support frame, each of the second wires being extended in a second direction in the opening, both ends of each of the second wire being connected to the inner wall of the support frame, the first direction being substantially perpendicular to the second frame, both ends of each of the third wires being connected to two neighboring first wires respectively to block a portion of a window formed by the first and second wires from the atomic beam.

12. The method of claim 1, wherein the atomic beam is irradiated only in the second region of the first alignment film via a second floating mask having a fourth opening that exposes the second region, the second floating mask being disposed over the first alignment film.

13. The method of claim 12, wherein the second floating mask comprises a support frame, and a plurality of first, second and third wires, the support frame having an opening at a center portion of the support frame, each of the first wires being extended in a first direction in the opening, both ends of each of the first wires being connected to an inner wall of the support frame, each of the second wires being extended in a second direction in the opening, both ends of each of the second wire being connected to the inner wall of the support frame, the first direction being substantially perpendicular to the second frame, both ends of each of the third wires being connected to two neighboring first wires respectively to block a portion of a window formed by the first and second wires from the atomic beam.

14. A method of manufacturing a liquid crystal display device, comprising:
forming first and second electrodes on a first substrate;
forming a first alignment film on the first substrate;
irradiating an atomic beam in a first alignment region of the first alignment film in a first direction, the first alignment region corresponding to a first region of the first electrode;
irradiating the atomic beam in a second alignment region of the first alignment film in a second direction, the second alignment region corresponding to a second region of the first electrode; and
assembling the first substrate with a second substrate.

15. The method of claim 14, wherein at least one first region and at least one second region are formed on the first electrode.

16. The method of claim 14, wherein the first and second region alternate with each other.

17. The method of claim 14, wherein the second substrate comprises a color filter facing the first electrode of the first substrate.

18. The method of claim 14, wherein the first substrate comprises a color filter covering the first electrode.

19. The method of claim 14, wherein the first and second electrodes are formed in the first substrate, the first and second electrodes being in parallel with each other.

20. The method of claim 14, wherein the second substrate comprises a second alignment film formed thereon, the second alignment film facing the first alignment film of the first substrate, the atomic beam being irradiated in a third alignment region of the second alignment film in a third direction, the third alignment region corresponding to the first region of the first electrode, the atomic beam being irradiated in a fourth alignment region of the second alignment film in a fourth direction, the fourth alignment region corresponding to the second region of the first electrode.

21. The method of claim 20, wherein the first and second directions are in parallel with the third and fourth directions respectively.

22. The method of claim 20, wherein a liquid crystal layer is disposed between the first and second alignment films, liquid crystal molecules of the liquid crystal layer are vertically aligned with respect to the first and second alignment films.

23. The method of claim 20, wherein the third direction forms a first angle with respect to the first direction, and the fourth direction forms a second angle with respect to the second direction, the first and second angles being in a range from about 90° to about 270° respectively.

24. The method of claim 23, wherein a liquid crystal layer is disposed between the first and second alignment films, liquid crystal molecules of the liquid crystal layer are aligned to form a spiral shape.

25. A method of manufacturing a liquid crystal display device, comprising:
forming a first electrode on a first substrate;
forming a second electrode on a second substrate;
forming a first alignment film on the first substrate;
irradiating an atomic beam in a first alignment region of the first alignment film in a first direction, the first alignment region corresponding to a first region of the first electrode;
irradiating the atomic beam in a second alignment region of the first alignment film in a second direction, the second alignment region corresponding to a second region of the first electrode; and
assembling the first substrate with a second substrate.

26. The method of claim 25, wherein a count (or number) of each of the first and second regions is at least one.

27. The method of claim 25, wherein the first and second regions alternate with each other.

28. The method of claim 25, wherein the second substrate is assembled with the first substrate, such that the second electrode faces the first electrode.

29. The method of claim 25, wherein the second substrate comprises a color filter facing the first electrode of the first substrate.

30. The method of claim 25, wherein the first substrate comprises a color filter covering the first electrode.

31. The method of claim 25, wherein the second substrate comprises a second alignment film formed thereon, the second alignment film facing the first alignment film of the first substrate, the atomic beam being irradiated in a third alignment region of the second alignment film in a third direction, the third alignment region corresponding to the first region of the first electrode, the atomic beam is irradiated in a fourth alignment region of the second alignment film in a fourth direction, the fourth alignment region corresponding to the second region of the first electrode.

32. The method of claim 31, wherein the first and second directions are parallel with the third and fourth directions respectively.

33. The method of claim 32, wherein a liquid crystal layer is disposed between the first and second alignment films, liquid crystal molecules of the liquid crystal layer are vertically aligned with respect to the first and second alignment films.

34. The method of claim 31, wherein the third direction forms a first angle with respect to the first direction, and the fourth direction forms a second angle with respect to the second direction, the first and second angles being in a range from about 90° to about 270° respectively.

35. The method of claim 34, wherein a liquid crystal layer is disposed between the first and second alignment films, liquid crystal molecules of the liquid crystal layer are aligned to form a spiral shape.

36. A liquid crystal display device comprising:
first and second substrates facing with each other;
first and second electrodes disposed between the first and second substrates;
a first alignment film formed on the first substrate, the first alignment film having first and second polarized functional groups for aligning liquid crystal molecules, the first polarized functional group being formed on a first alignment region corresponding to a first region of the first electrode, the first polarized functional group being formed in a first direction, the second polarized functional group being formed on a second alignment region corresponding to a second region of the first electrode, the second polarized functional group being formed in a second direction;
a second alignment film formed on the second substrate; and
a liquid crystal layer interposed between the first and second substrates.

37. The liquid crystal display device of claim 36, wherein a count (or number) of each of the first and second regions is no less than one.

38. The liquid crystal display device of claim 36, wherein the first and second regions alternate with each other.

39. The liquid crystal display device of claim 36, wherein the first electrode is disposed in the first substrate, and the second electrode is disposed in the second substrate.

40. The liquid crystal display device of claim 36, wherein the first and second substrates are disposed on the first substrate, such that the first and second substrates are in parallel with each other.

41. The liquid crystal display device of claim 36, wherein the second alignment film comprises third and fourth polarized functional groups for aligning liquid crystal molecules, the third polarized functional group being formed in a third alignment region corresponding to a first region of the first electrode, the third polarized functional group being formed in a third direction, the fourth polarized functional group being formed on a fourth alignment region corresponding to a second region of the first electrode, the fourth polarized functional group being formed in a fourth direction.

42. The liquid crystal display device of claim 41, wherein the first and second directions are in parallel with the third and fourth directions respectively.

43. The liquid crystal display device of claim 42, wherein a liquid crystal layer is disposed between the first and second alignment films, liquid crystal molecules of the liquid crystal layer are vertically aligned with respect to the first and second alignment films.

44. The liquid crystal display device of claim 41, wherein the third direction forms a first angle with respect to the first direction, and the fourth direction forms a second angle with respect to the second direction, the first and second angles being in a range from about 90° to about 270° respectively.

45. The method of claim 44, wherein a liquid crystal layer is disposed between the first and second alignment films, liquid crystal molecules of the liquid crystal layer are aligned to form a spiral shape.

46. A liquid crystal alignment apparatus comprising:
a base body that supports a substrate having first and second faces, an alignment film being formed on the first face;
an atomic beam generator irradiating an atomic beam, the atomic beam generator moving along the alignment film to scan the alignment film; and
an atomic beam blocking unit disposed between the base body and the atomic beam generator, the atomic beam blocking unit including a mask having an opening, the atomic beam generated from the atomic beam generator being irradiated onto a portion of the alignment film, the portion of the alignment film being exposed through the opening of the mask.

47. The liquid crystal alignment apparatus of claim 46, wherein the atomic beam generator comprises:
an ion generator dissociating atoms to form ions;
an ion accelerator accelerating the ions to form an ionic beam; and
a neutralizer neutralizing the ionic beam to form an atomic beam.

48. The liquid crystal alignment apparatus of claim 47, further comprising an angle adjuster that adjusts an irradiation angle of the atomic beam.

49. The liquid crystal alignment apparatus of claim 46, wherein the atomic beam blocking unit further comprises a mask supporter that supports the mask for preventing a sag of the mask.

50. The liquid crystal alignment apparatus of claim 49, wherein the mask supporter corresponds to no less than one protrusion that makes contact with the alignment film of the substrate.

51. The liquid crystal alignment apparatus of claim 49, wherein the mask supporter corresponds to a quartz bar extending along a portion of the mask, the portion being disposed between the openings of the mask.

52. The liquid crystal alignment apparatus of claim 49, wherein the mask supporter corresponds to a support wire extending along a portion of the mask, the portion being disposed between the openings of the mask.

53. The liquid crystal alignment apparatus of claim 49, wherein the mask supporter makes contact with the second face of the substrate.

54. The liquid crystal alignment apparatus of claim 49, wherein a longitudinal direction of the mask supporter is substantially in parallel with a direction of scanning of the atomic beam generator.

55. A liquid crystal alignment apparatus comprising:
a base body that supports a substrate having an alignment film formed thereon;
a housing disposed over the base body, the housing having an opening;
a lift unit disposed on the base body, the lift unit being combined with the housing to lift the housing;
an atomic beam blocking unit having a window, the atomic beam blocking unit covering the opening of the housing; and
an atomic beam generating unit disposed in the housing, the atomic beam generating unit moving along the alignment film to irradiate atomic beam onto the alignment film selectively via the window.

56. The liquid crystal alignment apparatus of claim 55, wherein a transferring unit is formed in the cover, the transferring unit moving the atomic beam generating unit.

57. The liquid crystal alignment apparatus of claim 55, wherein the lift unit includes a lift bar erected on the base body, and a lift body that moves along the lift bar.
